(19) United States
(12) Patent Application Publication
(10) Pub. No.: US 2021/0209888 A1
(43) Pub. Date: Jul. 8, 2021

(54) VENDING MACHINE

(71) Applicant: EVOCA S.P.A., Milano (IT)

(72) Inventor: Marco Rota, Milano (IT)

(21) Appl. No.: 17/058,837

(22) PCT Filed: May 31, 2019
(86) PCT No.: PCT/IB2019/054538

§ 371 Date: Nov. 25, 2020

(30) Foreign Application Priority Data
Jun. 1, 2018 (IT) 102018000005955

(51) Int. Cl. G07F 11/36; G07F 11/42

(52) U.S. Cl. CPC G07F 11/36; G07F 11/007; G07F 11/42

(57) ABSTRACT

A vending machine has a plurality of dispensing trays, each of which supports a plurality of products and is provided with an interchangeable lower plate coupled to a lower support frame, a plurality of supply channels, a product feeder to feed the products along each supply channel, and a driver to move the product feeder along the supply channel; the drivers are coupled to an interchangeable rear support frame.

### CROSS-REFERENCE TO RELATED APPLICATIONS

This patent application claims priority from Italian patent application no. 102018000005955 filed on 1 Jun. 2018, the entire disclosure of which is incorporated herein by reference.

### TECHNICAL FIELD OF THE INVENTION

The present invention relates to a vending machine.

### STATE OF THE ART

In particular, the present invention relates to a vending machine comprising a cabinet defining a dispensing compartment; a front door to close the dispensing compartment; and a plurality of dispensing trays arranged inside the dispensing compartment to support respective pluralities of products.

Each dispensing tray slidably engages a guide device comprising a pair of guides connected to the cabinet on opposite sides of the dispensing tray.

Each dispensing tray comprises a lower plate; a plurality of partition walls releasably connected to the lower plate to define a plurality of parallel supply channels; a rear support frame; and, for each supply channel, a respective feeding unit to advance the products along the supply channel.

Each feeding unit comprises a helical or spiral conveyor to feed the products along the relevant supply channel; and a drive device mounted on the rear support frame to move the helical conveyor around a given rotation axis and along the supply channel.

Although the positions of the partition walls on the lower plate and the positions of the drive devices along the rear support frame can be selectively controlled, the known vending machines of the type described above in any case have relatively low flexibility and versatility, allowing a relatively small number of product format changes.

A dispensing tray of the type specified above is known, for example, from EP 0 258 954 A2.

### OBJECT AND SUMMARY OF THE INVENTION

The object of the present invention is to provide a vending machine free of the above-described drawbacks and simple and inexpensive to implement.

According to the present invention, a vending machine is provided, as claimed in the appended claims.

### BRIEF DESCRIPTION OF THE DRAWINGS

The present invention will now be described with reference to the appended drawings, which illustrate a non-limiting embodiment thereof, wherein:

FIG. 1 is a schematic perspective view, with parts removed for the sake of clarity, of a preferred embodiment of the vending machine according to the present invention;

FIG. 2 is an exploded perspective view of a detail of the vending machine in FIG. 1;

FIGS. 3 and 4 are two perspective views of the detail in FIG. 2;

FIG. 5 is an exploded perspective view of a detail in Figures from 2 to 4;

FIG. 6 is an exploded perspective view of a variant of the detail in FIG. 2;

FIGS. 7 and 8 are two perspective views of the detail in FIG. 6;

FIG. 9 is a perspective view of a detail in FIGS. 7 and 8; and

FIG. 10 is an exploded perspective view of the detail in FIG. 9.

### DETAILED DESCRIPTION OF A PREFERRED EMBODIMENT OF THE INVENTION

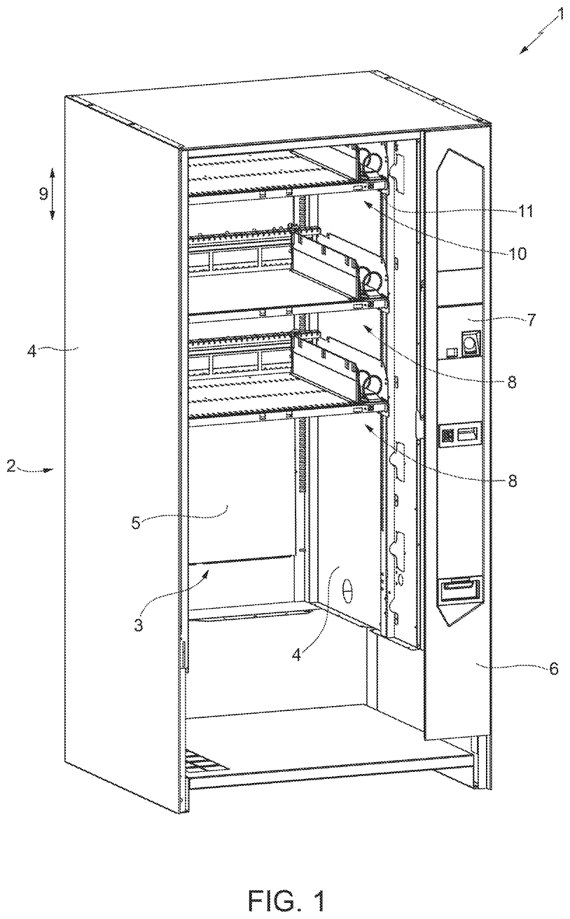

With reference to FIG. 1, reference numeral 1 indicates, as a whole, a vending machine for dispensing products (not shown).

The vending machine 1 comprises a cabinet 2 internally defining a dispensing compartment 3 bounded by two substantially parallel lateral walls 4 and a rear wall 5 substantially perpendicular to the walls 4, and is closed by an at least partially transparent front door 6.

A tilting panel (not shown) is provided at a lower portion of the door 6 and defines a collection chamber which is in communication with the compartment 3 and is openable by a user to pick up a product (not shown) previously selected by means of a selection panel 7 provided along a side edge of the door 6.

The compartment 3 internally houses a plurality of dispensing trays 8, which are arranged one over the other in a substantially vertical direction 9, extend between the walls 4, and each support a respective plurality of products.

Each tray 8 has a depth, as measured perpendicularly to the wall 5, less than a distance between the wall 5 and the door 6, which is also measured perpendicularly to the wall 5, so as to define a falling space in communication with the collection chamber of the tilting panel of the door 6.

Each tray 8 slidably engages a guide device 10 comprising a pair of rectilinear guides 11 connected to the walls 4 on opposite sides of the tray 8.

The tray 8 is movable along the guides 11 between a dispensing position (FIG. 1), in which the tray 8 is arranged inside the cabinet 2 for dispensing the products, and a loading position (not shown), in which the tray 8 projects outside the cabinet 2 to allow the products to be loaded onto the tray 8.

As shown in Figures from 2 to 5, each tray 8 comprises a support frame 12, which has a quadrilateral shape, is provided with a row of slots 13 distributed along a rear edge thereof with a substantially constant distribution pitch, and is also provided with a row of slots 14 distributed along a front edge thereof with a substantially constant distribution pitch.

The slots 13, 14 of each row of slots 13, 14 are aligned with each other in a horizontal direction 15.

The frame 12 carries an upper plate 16, preferably made of a transparent material, and is bounded by two lateral walls 17 fixed to the frame 12 perpendicularly to the plate 16 and to direction 15.

The plate 16 is an interchangeable plate to be changed depending on the shape of the products arranged on the tray 8, is fixed to the frame 12 by a plurality of fastening screws and/or hooks (not shown), and is provided with a number of rows of slots 18 parallel to each other and to direction 15.

The tray 8 further comprises a plurality of parallel partition walls 19 mounted between the walls 17.

Each wall 19 is provided with fastening teeth 19a, which engage the slots 18 of a respective row of slots 18 to releasably connect the wall 19 to the plate 16.

The walls 17 and 19 define therebetween a plurality of supply channels 20, which extend in a horizontal direction 21 orthogonal to directions 9 and 15, and are associated with respective product feeding units 22 operable to advance the products along the channels 20.

Each unit 22 comprises a feed track 23, which is mounted above the plate 16 and is connected to the frame 12 through a tooth 24 formed on the track 23 and engaging a relevant slot 14 of the frame 12; a helical conveyor 25, which is rotatably mounted about an axis of rotation 26 parallel to direction 21 and extends between the plate 16 and the track 23; and a drive device 27 operable to move the conveyor 25 around and along the axis 26.

The device 27 comprises an electric motor 28 and a reduction geartrain 29, an output shaft 30 of which is angularly fixed coupled to an input shaft 31 of the conveyor 25.

The drive devices 27 of the feeding units 22 are releasably coupled to a support frame 32, which has an elongated rectangular shape, extends in direction 15, is connected to the frame 12 by means of a pair of teeth 33 engaging respective slots 34 formed in the frame 12, and is fixed to the lateral walls 17 of the tray 8 by known fastening screws (not shown).

The frame 32 is an interchangeable frame to be changed depending on the conveyor 25 to be chosen according to the shape of the products arranged on the tray 8, has a row of upper slots 35 aligned with each other in direction 15, and is also provided with a row of lower slots 36 aligned with each other in the same direction 15.

Each drive device 27 is releasably connected to the frame 32 by means of a pair of upper, elastically deformable teeth 37 engaging respective slots 35 and of a lower tooth 38 engaging a respective slot 36.

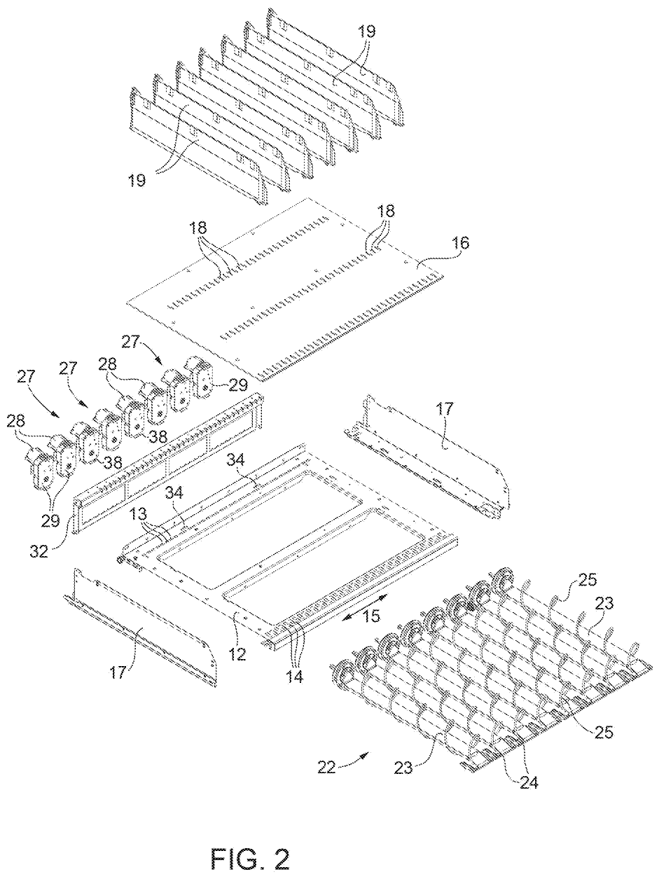

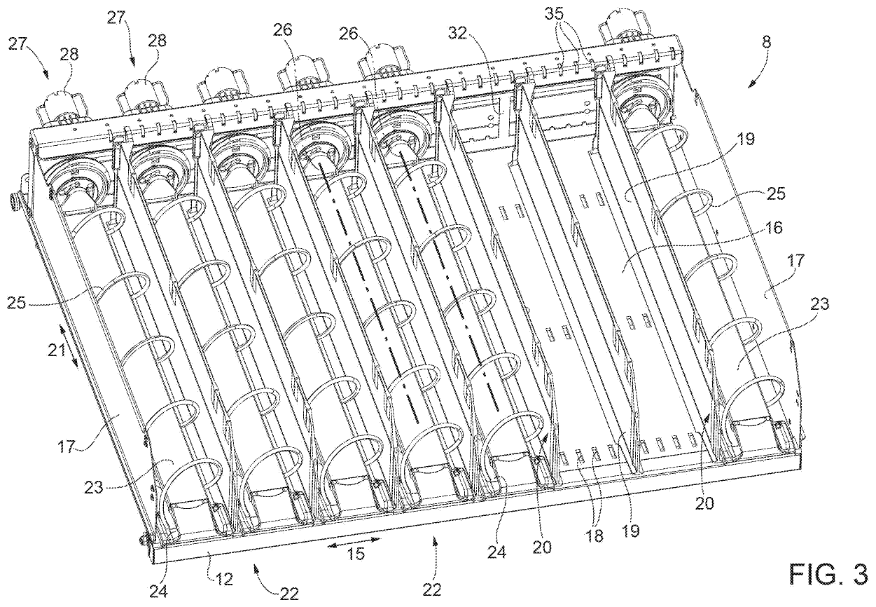

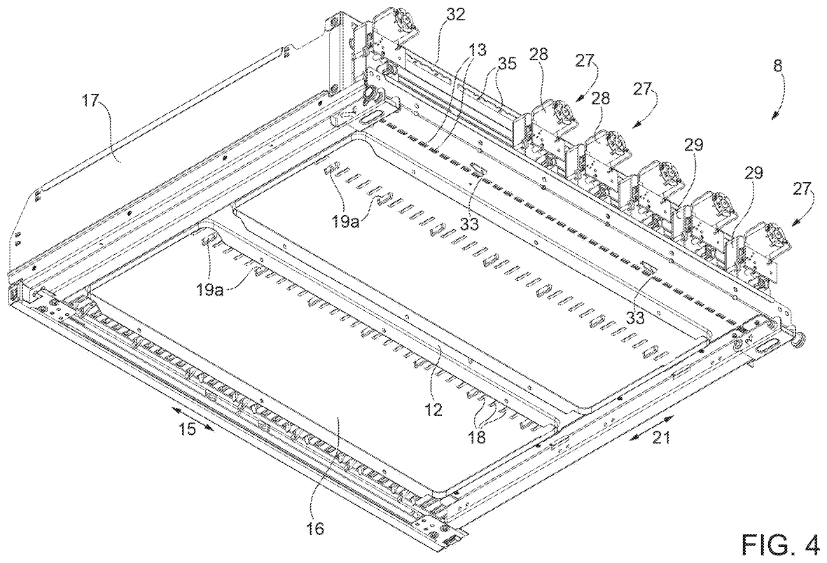

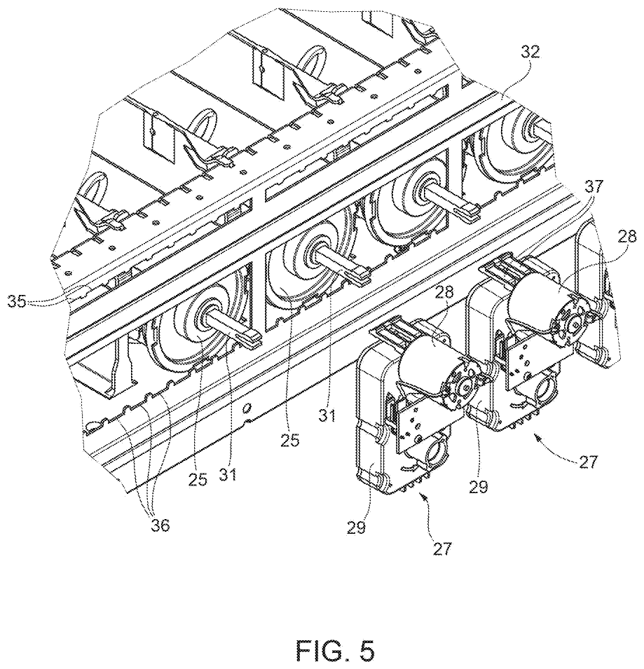

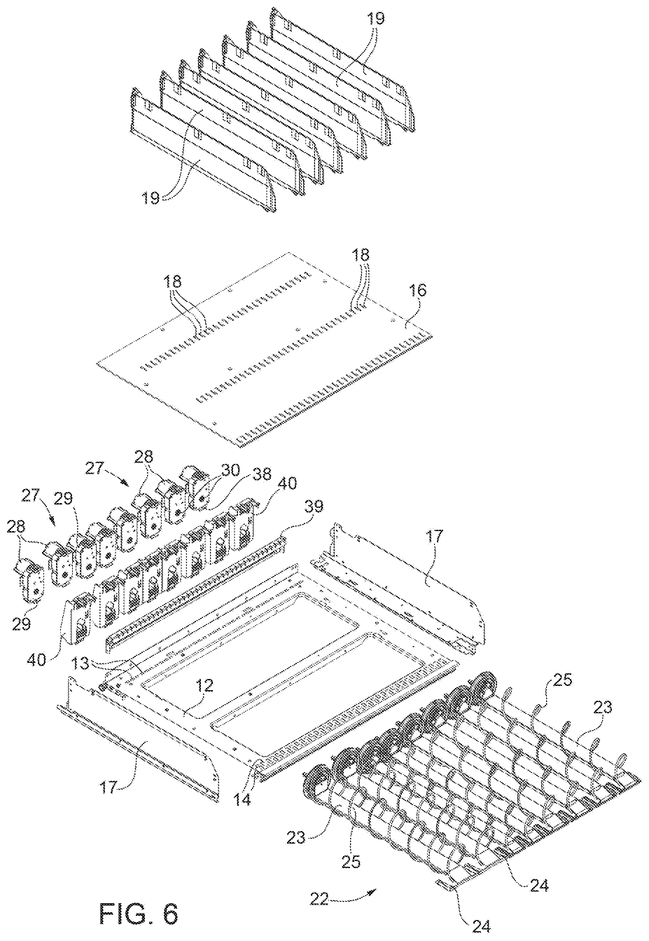

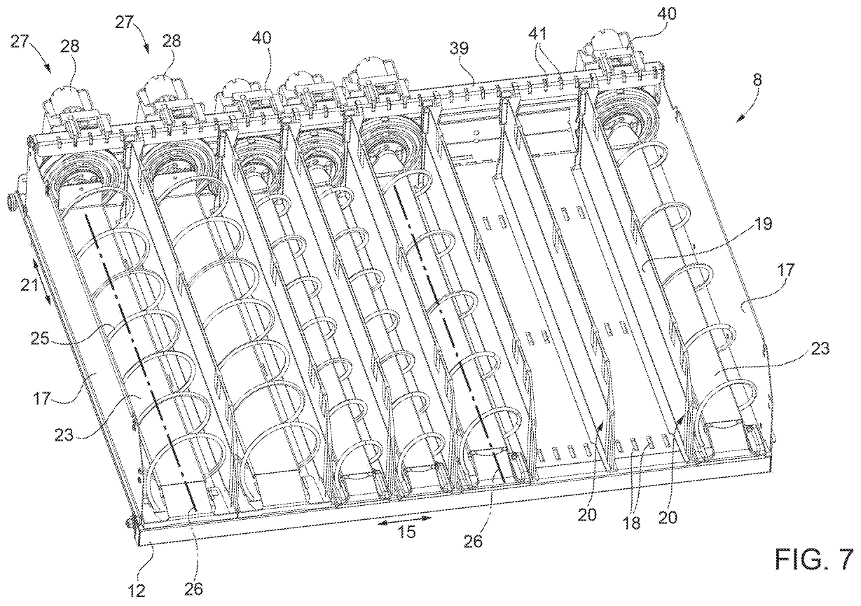

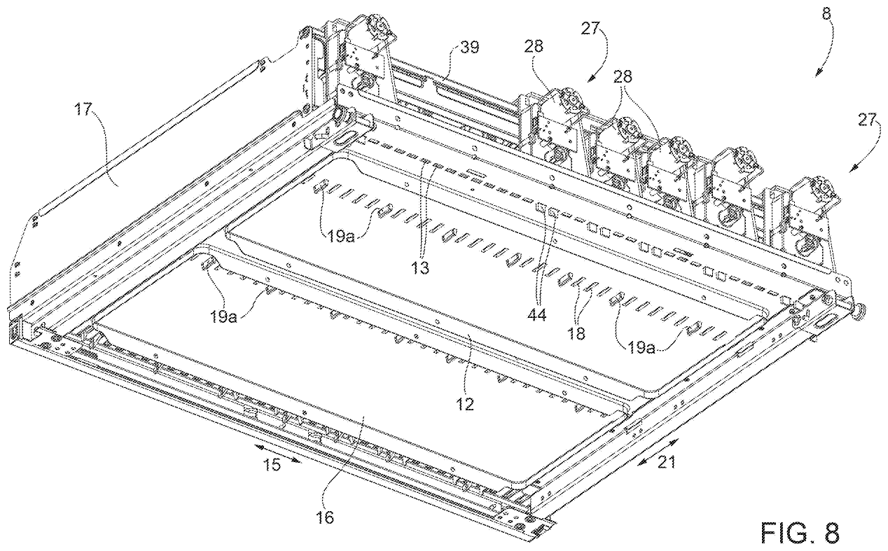

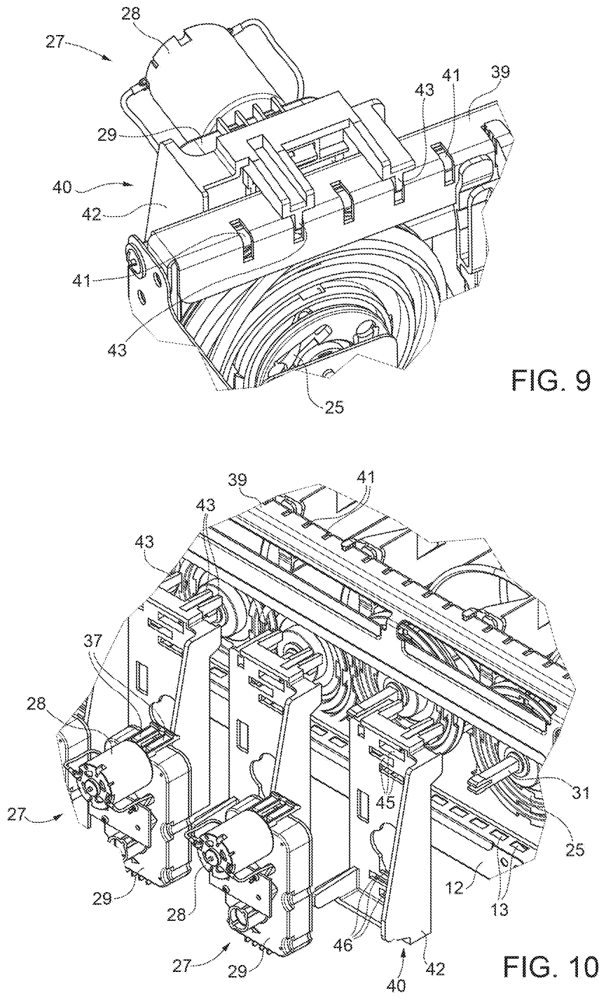

The embodiment shown in FIGS. 6 to 10 differs from the one shown in FIGS. 2 to 5 in that:
the support frame 32 is replaced with an interchangeable support frame 39; and
each drive device 27 is releasably connected to the frame 39 via an adapter 40.

The frame 39 extends between the walls 17 in direction 15, is releasably fixed to the walls 17 by known fastening screws (not shown), and has a plurality of slots 41 aligned with each other in the same direction 15.

Each adapter 40 comprises a support plate 42, which is provided with a pair of front teeth 43 releasably coupleable to respective slots 41 of the frame 39, and with a pair of lower teeth 44 releasably coupleable to corresponding slots 13 of the frame 12.

The plate 42 also has a first group of three rear slots 45, which are configured to receive and hold the upper teeth 37 of the device 27 and are mutually offset both in direction 9 and in direction 15, to allow different coupling positions of the device 27 relative to the device 40.

Lastly, the plate 42 is provided with a second group of three rear slots 46, which are configured to receive and hold the lower tooth 38 of the device 27 and are mutually offset both in direction 9 and in direction 15, to allow different coupling positions of the device 27 relative to the device 40.

Interchangeability of the lower plate 16 and the support frames 32, 39 and the releasable couplings between the drive devices 27 and the support frame 32, on the one hand, and among the drive devices 27, the adapters 40 and the support frame 39, on the other hand, guarantee relatively high flexibility and versatility to the vending machine 1, allowing a relatively high number of changes in the shape of the products.

In other words, the vending machine 1 allows each tray 8 to be configured with supply channels 20 of different widths, the use of helical conveyors 25 of different diameters, and the trays 8 to be reconfigured each time in a relatively quick and simple manner based on the size of the products.

1-12. (canceled)

13. A vending machine, comprising:
a cabinet internally defining a dispensing compartment closed by a front door;
a plurality of dispensing trays that are arranged in the dispensing compartment one over the other, each of the plurality of dispensing trays adapted to receive a respective plurality of products; wherein each of the plurality of dispensing trays includes:
a lower plate;
a plurality of partition walls releasably coupled to the lower plate to define a plurality of parallel supply channels;
a rear support frame, and, for each of the plurality of parallel supply channels, a respective product feeding unit to feed products along the parallel supply channel;
wherein each product feeding unit includes product feeding conveyor to feed the products along the relevant parallel supply channel; and a drive device mounted on the rear support frame to operate the product feeding conveyor to feed the products along the parallel supply channel;
a lower support frame on which the lower plate and the rear support frame are mounted; wherein the lower plate and/or the rear support frame are interchangeable to reconfigure the vending machine based on the shape of the products to be dispensed;
a first coupling is provided to releasably couple the lower plate to the lower support frame; and
a second coupling is provided to releasably couple the rear support frame to the lower support frame.

14. The vending machine of claim 13, wherein the product feeding conveyor is mounted above the lower plate and are releasably coupled to the lower support frame.

15. The vending machine of claim 13, wherein the dispensing tray is bounded by two lateral walls releasably coupled to the lower support frame.

16. The vending machine of claim 13, further comprising a third coupling to releasably couple each drive device directly to the rear support frame.

17. The vending machine of claim 16, wherein the third coupling includes, for each drive device, at least one respective fastening tooth carried by the drive device, and at least one respective slot formed in the rear support frame to receive and hold the fastening member.

18. The vending machine of claim 17, wherein each second fastening tooth is elastically mounted to move between a fastening position and an unfastening position.

19. The vending machine of claim 13, wherein each drive device is releasably coupled to the rear support frame via an adapter.

20. The vending machine of claim 19, further comprising a fourth coupling to releasably couple each adapter to the rear support frame, and a fifth coupling to releasably couple each drive device to the respective adapter.

21. The vending machine of claim 20, wherein the fourth coupling includes at least one first fastening tooth carried by the adapter, and at least one first slot formed in the rear support frame to receive and hold the first fastening tooth.

22. The vending machine of claim 20, wherein the fifth coupling includes at least one second fastening tooth carried by the drive device, and at least one second slot formed in the respective adapter to receive and hold the second fastening tooth.

23. The vending machine of claim 22, wherein the at least one second fastening tooth is elastically mounted to move between a fastening position and an unfastening position.

24. The vending machine of claim 22, wherein the fifth coupling includes, for each second fastening tooth, at least two respective second slots, which are formed in the respective adapter, are mutually offset in a first direction substantially perpendicular to the lower plate, and are further mutually offset in a second direction substantially orthogonal to the first direction and substantially parallel to the lower plate.
